(19) United States
(12) Patent Application Publication
(10) Pub. No.: US 2006/0057384 A1
(43) Pub. Date: Mar. 16, 2006

(54) Methods for the fabrication of gold-covered magnetic nanoparticles

(76) Inventors: Benoit Simard, Orleans (CA); Jin Zhang, Kanata (CA); Yves Deslandes, Orleans (CA); Michael L. Post, Orleans (CA)

Correspondence Address: NATIONAL RESEARCH COUNCIL OF CANADA;1500 MONTREAL ROAD, BLDG M-58, ROOM EG12, OTTAWA, ONTARIO, K1A 0R6, CA

(21) Appl. No.: 11/092,717

(22) Filed: Mar. 30, 2005

Related U.S. Application Data
(60) Provisional application No. 60/602,629, filed on Aug. 19, 2004.
(60) Provisional application No. 60/558,106, filed on Apr. 1, 2004.

(51) Int. Cl. B32B 5/16; B22F 9/24

(52) U.S. Cl. 428/403; 427/212; 75/345

(57) ABSTRACT

There is disclosed an approach for the gold-coating of cores, such as magnetic nanoparticles. In some instances, the core and gold colloids can be fabricated first through irradiation, such as laser irradiation, and then mixed together for further laser irradiation. Alternatively, the cores may be fabricated using wet chemistry and subsequently coated using an irradiation method. Also disclosed is a two phase aqueous:oil system and its use in coating a material present in one phase with a second material present in the second phase.

This patent application claims priority from U.S. 60/602,629 and U.S. 60/558,106, filed 19 Aug. 2004 and 1 Apr. 2004, respectively.

### FIELD OF THE INVENTION

The invention relates to gold-covered cores and materials and methods for their fabrication.

### BACKGROUND OF THE INVENTION

Magnetic nano-sized materials have wide potential application in biological sciences and medicine. However, if left unprotected, the magnetic particles agglomerate, coalesce and then precipitate. In addition, the magnetic cores should not be in contact with the biological materials.

Several groups world-wide are attempting to develop methods to fabrication narrowly dispersed, small size (<10 nm), fully protected magnetic nanoparticles. Current techniques involve sequential synthesis of the various building blocks followed by co-precipitation or reactions to form the desired core-shell structures.

Formation of magnetic cores followed by the reduction of auric salts tends to lead to segregation of the constituents and oxidation of the core with the result that gold does not substantially cover the oxidized magnetic core.

It is an object of the invention to provide a method for gold-coating cores.

### SUMMARY OF THE INVENTION

There is disclosed herein a approach for the gold-coating of cores, such as magnetic nanoparticles. In some instances, the core and gold colloids can be fabricated first through irradiation and then mixed together for further irradiation. Alternatively, the cores may be fabricated using wet chemistry and subsequently coated using the irradiation method.

In an embodiment of the invention there is provided cores having a volume of no more than about 1.2×10⁻⁴ μm³, wherein the cores are substantially coated in gold. The cores may be magnetic or non-magnetic.

In an embodiment of the invention there is provided a method of coating cores with gold. The method comprises: obtaining cores in a suitable two phase oil:aqueous system wherein the aqueous phase includes suspended gold; and subjecting the cores to irradiation at a wavelength within about 30 nm of the surface plasmon resonance of gold.

In an embodiment of the invention there is provided the use of a two-phase system having an oil phase and a polar phase in the preparation of gold-coated cores.

In an embodiment of the invention there is provided a method of applying a material soluble in an aqueous phase to a second material which is susceptible to oxidation in an aqueous phase, so as to reduce oxidation of the second material beyond the level which would be expected in a single-phase aqueous system. The method comprises: a) obtaining the first material in an aqueous phase; b) obtaining the second material in an oil phase; c) combining the aqueous and oil phases to form a two-phase system; and d) inducing the formation of micelles or reverse micelles in the two-phase system.

In an embodiment of the invention there is provided a method for forming iron nanoparticles. The method comprises: obtaining Fe₂O₃ in a polar solvent; and irradiating the Fe₂O₃/solvent mixture, so as to produce Fe. In some instances about 40 and 100 mJ of total laser energy input is provided at between about 15 to 25 Hz.

In an embodiment of the invention there is provided a method of producing a fluid containing fragmented melted gold suitable for coating on a surface. The method comprises: obtaining a polar solvent containing suspended gold; and irradiating the polar solvent containing gold at a wavelength within 30 nm of the plasmon resonance peak of gold.

### BRIEF DESCRIPTION OF THE FIGURES

FIG. 1 is a photographic depiction of the results of Example 1.

FIG. 2 is a transmission electronmicrograph (TEM) depiction of the results of Example 1.

FIG. 3 is an HRTEM micrograph depiction of the results of Example 1.

FIG. 4 is a schematic depiction of the process described in Example 1.

FIG. 5 is a graphical depiction of UV-vis spectra: (a) Plasmon absorption of colloidal solutions with Fe@Au nanoparticles; (b) Plasmon absorption of water with CTAB after separating Fe@Au nanoparticle by magnets; (c) Plasmon absorption of colloidal solutions when separated Fe@Au nanoparticle by magnets re-dispersed in toluene and dodecanethiol all from Example 1.

FIG. 6 is a schematic depiction of possible intermediate stages in the process depicted in FIG. 4.

FIG. 7 is a schematic depiction of an alternative process to that depicted in FIG. 4.

FIG. 8 is a schematic depiction employed in Example 2 for fabricating Au coated Fe nanoparticles.

FIG. 9 is a bright field TEM micrographs depiction of the results of Example 2 (a) Fe@Au particles before acid treatment; (b) Fe@Au particles after acid treatment.

FIG. 10 is a Haadf TEM of the acid-treated Fe@Au particles depiction of the results of Example 2.

FIG. 11 depicts HRTEM micrographs of representative Fe@Au particles from the examples after the acid treatment.

FIG. 12 depicts XRD pattern of the acid treated Fe@Au core shell particles.

FIG. 13 depicts FT-Raman of Fe@Au NPs binding with HS—C₁₁H₂₂—OH in CH₂Cl₂ from the examples.

FIG. 14 depicts example zero-field cooling ZFC and field cooling FC procedures.

### DETAILED DESCRIPTION OF THE PREFERRED EMBODIMENTS

It will be appreciated that the method disclosed herein can also be used to coat non-magnetic cores and other magnetic cores, such as cobalt, nickel, and ferrite cores. Cores may be of any convenient size but are preferably no larger than 1 μm³. In some instances it will be desirable to use core having a volume of less than 0.75 μm³, in some instances it will be desirable to use core having a volume of less than 0.5 μm³, in some instances it will be desirable to use core having a volume of less than 0.5 μm³, in some instances it will be desirable to use core having a volume of less than 0.2 μm³, in some instances it will be desirable to use core having a volume of less than 0.1 μm³, in some instances it will be desirable to use core having a volume of less than 0.0001 μm³. In some instances it will be desirable to use core having a diameter of less than 50 nm, in some instances it will be desirable to use core having a diameter of less than 20 nm, in some instances it will be desirable to use core having a diameter of less than 15 nm. In some instances it will be useful to use super paramagnetic particles.

It will be appreciated that some variation on the irradiation parameters disclosed herein is contemplated. In some instances it will be desirable to use a wave length which coincides with a surface plasmon resonance of gold or is within 30 nm of it (higher or lower). In some instances the irradiation wave length may in fact be a band or group of wavelengths centered on or having a significant concentration around the wavelength of interest. In some instances the total band width will be no more than 100 nm (e.g. 50 nm on either side) of the wavelength of interest. In some instances a wavelength of within 20 nm (higher or lower) of the surface plasmon resonance of gold. In some instances it will be desirable to adjust the laser ablation and irradiation parameters to keep the total photon input within 50%, 25%, 10% or 5% of the total photon input disclosed herein. While the invention has been illustrated with reference to the use of pulsed laser light, it will be appreciated that gold-coating of cores could be carried out using non-pulsed laser light or non-coherent light.

In light of the disclosure herein it will be apparent to one skilled in the art to select irradiation wavelength and total energy input suitable to the reagent concentrations and solutions employed in a particular case.

In some instances the use of pulsed laser light will be preferred in fabrication nanoparticles.

In some instances it is desirable to have the coating process occur in a two phase liquid system. In some instances it is desirable to have the coating occur in the interface region of two phases. In some instances one phase is an aqueous phase, and the other phase is an oil phase.

In some instances the aqueous phase is predominately, substantially, or entirely water, another aqueous media, or an organic polar solvent such as propanol or butanol, or a combination thereof. In some instances an aqueous media will be preferred. In some instances, one skilled in the art, in light of the disclosure herein, will select a suitable aqueous phase in light of the precursor to be used in producing the core. (For example, solvents such as propanol and butanol are useful in making cores for metal salts or metal oxides. This approach allows nanoparticle fabrication without use of a reducing agent.)

In some instances one may wish to choose the aqueous solvent characteristics of pH and ion concentration in order to impact the size and shape of core formed, particularly where the core is a nanoparticle. The aqueous solvent preferably has gold dissolved and/or suspended in it. The concentration of gold in the aqueous solvent will in some instances preferably be between 1 mg/ml and 10 mg/ml, more preferably between 1.2 mg/ml and 2 mg/ml. The concentration (by mass/vol) or gold in the polar solvent will in some instances preferably be as high or higher than the concentration of core material in the oil phase.

In some instances a micelle former, which is capable of inducing the formation of micelles and/or reverse micelles in the aqueous phase:oil phase two phase system is employed. Micelle formers include surfactants and other amphipathic molecules suitable for use with a particular 2-phase system. The micelle former may be present at a concentration of 0.04 mol/l to 0.02 mol/l. In some instances the micelle former will be selected for an ability to induce phase transitions in microemulsions in the 2-phase system.

In some instances a co-surfactant will also be employed. A cosurfactants may be a compound which would also be suitable for use as a micelle former, or it may be another compound selected for its ability to assist the micelle-former in inducing phase transitions. A co-surfactant, when employed, will in some instances preferably reduce interfacial tension between phases to facilitate the formation of very small “particles” of dispersed phase. A number of suitable co-surfactants will be apparent to those skilled in the art, in light of the disclosure herein. By way of non-limiting example, hexanol, butanol, pentanol, octanol, and similar intermediate-chain alcohols (preferably C₄-C₈ straight chain alkanols) will sometimes be selected for use (singly or in combination) as co-surfactants.

Micelle-formers may be selected in light of the exact parameters of the system being used. In some instances surfactants such as CTAB, cationic surfactants, such as dodecyltrimethylammonium bromide (DTAB), 1,2-bis(dodecyltrimethyl ammonio) ethane dibromide (2RenQ); anionic surfactant, e.g. sodium dodecyl sulfate (SDS), and sodium bis(2-ethylhexyl)sulfosuccinate (AOT); can also be used as surfactant for the formation of Au nanoparticles in the 2-phase system. Furthermore, it is possible to have two or more surfactants used at same time in either the aqueous or the oil phase, or both.

In some instances an antioxidant is employed.

In some instances “CTAB” (hexadecyltrimethyl-amonium (C₁₉H₄₂BrN)) is employed. In some instances it will be preferred to use a cationic surfactant.

Preferably, the two-phase system has an oil:water ratio of between 3:15 and 3:1, preferably between 3:10 and 3:2. The “oil” phase may be comprised of any one or a mixture of suitable organic solvents such as a C₈-C₉ alkane such as octane or a C₁₁-C₁₅ such as dodecane. Other organic solvents will be apparent in light of the disclosure herein. In general the solvent will be selected in light of the photosensitivity of the core-forming particles under laser irradiation. In some instances, C₄-C₁₅ alkanes, >C₁₅ alkanes, C₈-C₁₅ or >C₁₅ alkenes and/or phenyl-substituted organics (alone or in combination) may form a majority, substantially all, or entirely all of the oil phase.

In some instances the oil:water system also contains a lower alkyl alcohol such as 1-butanol. In some instances the lower alkyl alcohol is a C₃-C₆ primary alcohol. In some instances it is a C₃-C₆ secondary alcohol. The lower alkyl alcohol is preferably present in a ratio of 3:1 to 1:3 to the oil. In some instances a water:oil:alcohol ratio of about 4:2:1 to 2:1:2 will be desired. In some instances a water:oil:alcohol ratio of 2:1:1 will be desired.

While the invention is not limited to any particular mechanism or mode of action, it appears that certain aspects of the invention are impacted, or occur as follows: gold nanoparticles have an intense surface plasmon peak centering about 520 nm. During a single laser pulse (˜3 ns), one gold particle is considered to absorb several photons, and its internal energy rises significantly so that the gold particles is decomposed to nano, or subnano-scale particles under the 532 nm laser irradiation. Fe particles do not have such plasmon resonance in the visible light region, thus, Fe particles are relatively stable in oil phase. In addition, using a 2-phase system can provide advantages such as 1). Surfactant micellization is excellent in aqueous-organic mixed solvents, while formation of aggregates can occur in non-polar solvents and in polar solvents as well. Micelles enhance the formation of very small and uniform nanoparticles. Since the melting temperature decreases with particle size decreasing, small Au nanoparticles, or sub-nanoparticles produced through laser irradiation tend to have low melting temperatures. Co-surfactants and temperature can induce phase transitions in microemulsions to facilitate the tiny gold particles (in the nano, or sub-nano scale) to be nucleated and coated on the surface of Fe nanoparticles. Transition metal nanoparticles can be produced from metal salt, or metal oxide through laser irradiation without reducing agent in organic media. Thus, the laser method can protect Fe nanoparticles from oxidation in suitable organic solvent.

It is possible to readily identify and isolate those particles which are completely covered in gold by placing the particles in a strong acid solution or other suitable solution which reacts with exposed core material, leaving covered cores intact and available for isolation by magnetic or other suitable means.

Thus, there has been provided a method for gold-coating cores.

### Example 1

Monodispersed gold coated iron nanoparticles were prepared in water-in oil reverse microemulsion of CTAB (cetyltrimethyl-ammonium bromide)/octane (or dodecane)/butanol/water. Butanol acted as a co-surfactant.

### EXAMPLES

### Experimental Process

1. Laser ablation:
Solution A. Fe₂O₃ (50 mg)*¹ in butanol/octane (or dodecane*²) (15:15 ml) with CTAB (0.12 g), 50 ml H₂O
   *¹ The better results can be obtained when the concentration of Au is larger than that of Fe₂O₃
   *² from TEM results, nanoparticles with core-shell structured are succeed in both of solutions (water-octane and water-dodecane). However, homogenous fine nanoparticles are substantial in system water-octane.
1 h, 20 Hz, 250 mJ (65 mJ)
*Fe₂O red powder subjected to laser irradiation changed to black powder, most of the black powder is Fe which can be identified by XPS, or XRD.

2. Laser ablation:
Solution B. Au (90 mg)*¹ in butanol/octane (or dodecane*²) (15:15 ml) with CTAB (0.12 g), 50 ml H₂O
   *¹ The better results can be obtained when the concentration of Au is larger than that of Fe₂O₃
   *² from TEM results, nanoparticles with core-shell structured are succeed in both of solutions (water-octane and water-dodecane). However, homogenous fine nanoparticles are substantial in system water-octane.
Irradiation mixed solution (A+B) with 1 h, 20 Hz, 250 mJ (65 mJ)

3. Centrifuging for 10˜15 min to separate oil from water. (Particles suspend in water)

4. Collecting magnetic particles using magnets. (¹ Long time needed depending on the concentration of coated magnetic NP)
*¹ The better results can be obtained when the concentration of Au is larger than that of Fe₂O₃

5. Re-dispersing collected particles in toluene and dodecanthiol using ultrasonic method.

6. Ultrosonic process taken 1 hr (² depending on the concentration of collected coated magnetic NP), output: 5, Duty: 55
*² from TEM results, nanoparticles with core-shell structured are succeed in both of solutions (water-octane and water-dodecane). However, homogenous fine nanoparticles are substantial in system water-octane.

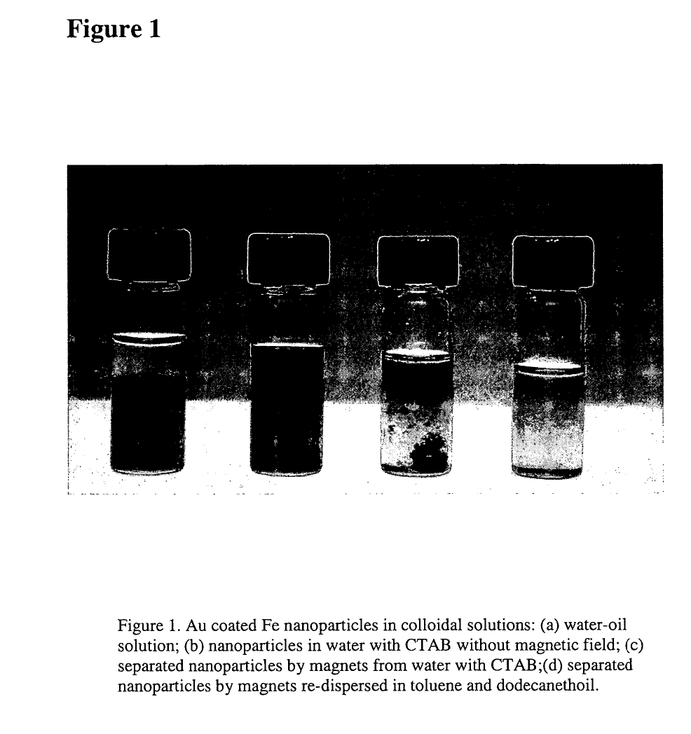

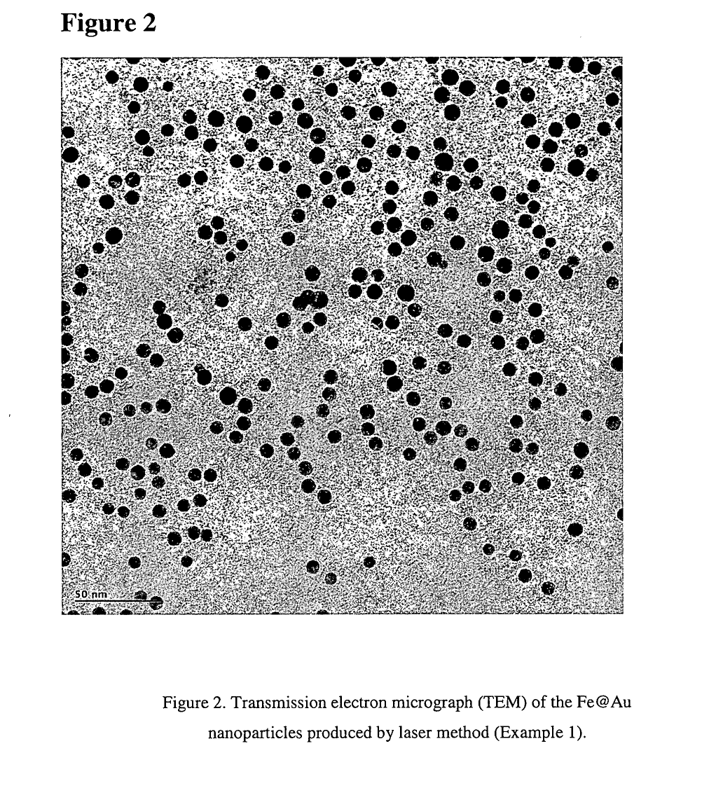

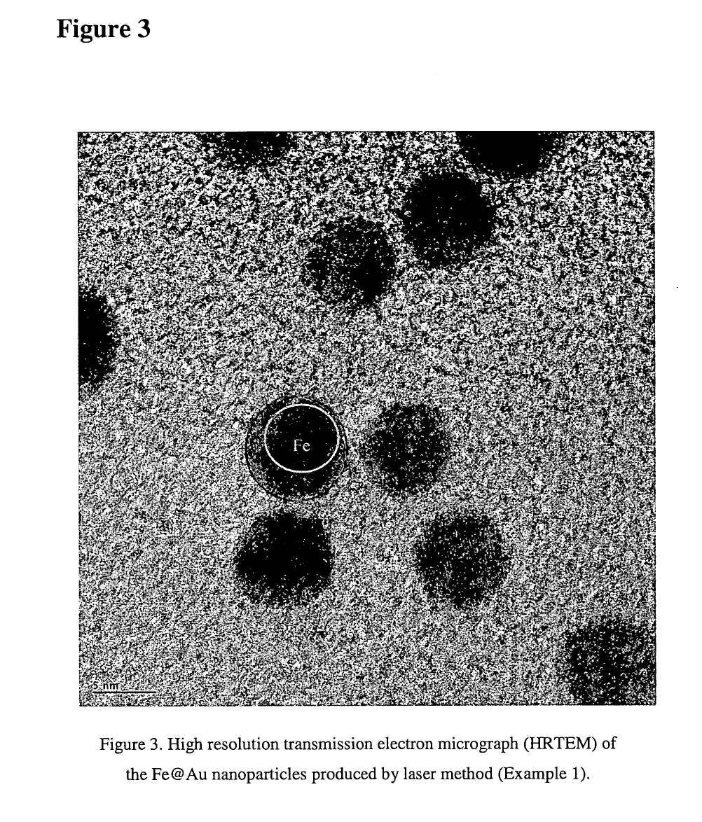

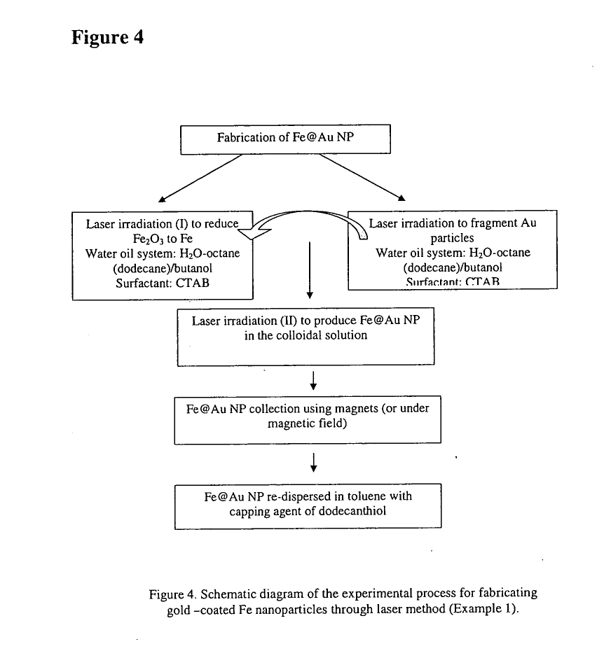

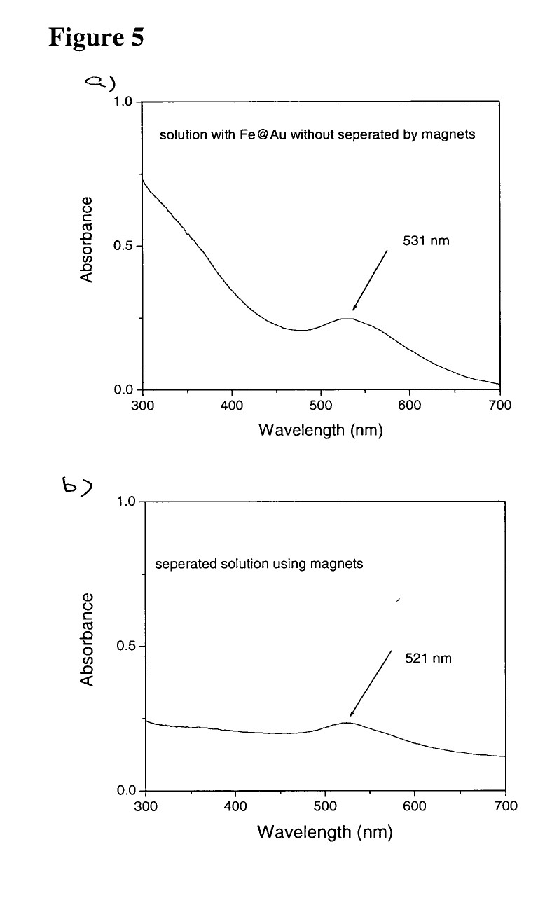

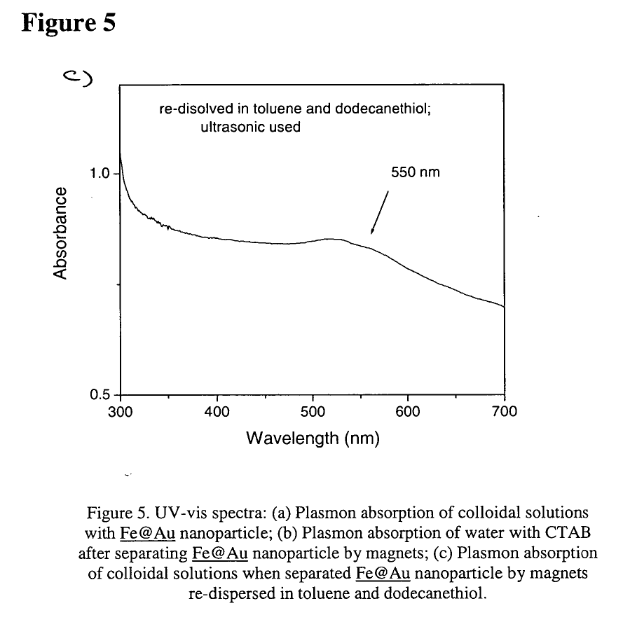

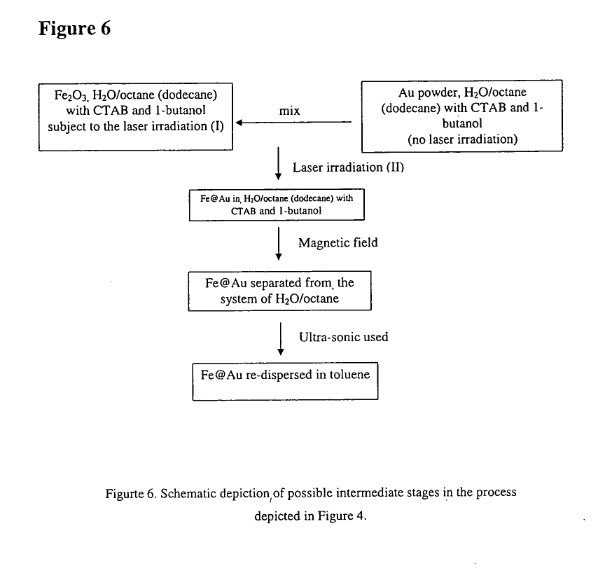

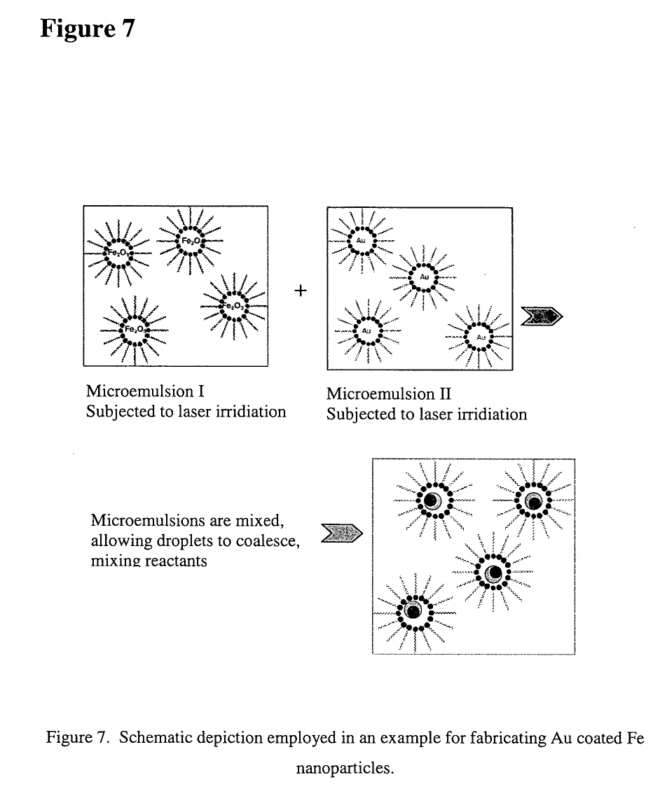

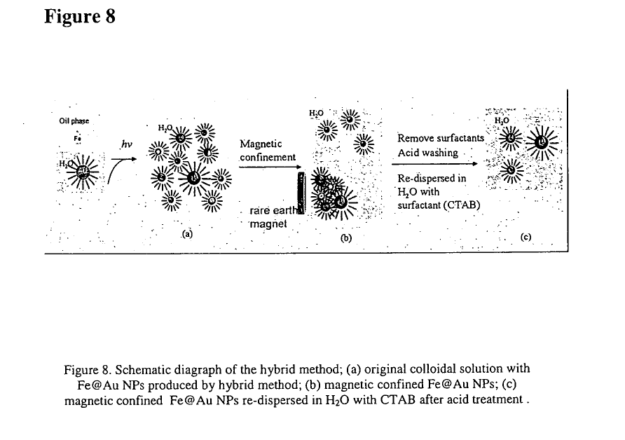

Results are depicted in FIG. 1 which shows Au coated nanoparticles in colloidal solutions, and wherein (a) water (down)-oil (up) solution; (b) nanoparticle in water with CTAB without magnetic field; (c) separated nanoparticle by magnets from water with CTAB; (d) separated nanoparticle by magnets re-dispersed in toluene and dodecanethiol (from FIG. 1). Further results are depicted in FIGS. 2, 3, and 5.

### Example 2

### Preparation of Gold Covered Zero-Valent Iron Nano-Particle's (Fe@Au) Using Wet Chemistry-Laser Massage Hybrid Method

The Fe@Au nano-particles can be prepared using two general routes. One route consists of making both the magnetic core and the gold shell using laser irradiation. The second route consists of preparing the magnetic core through “wet chemistry” methods and subsequently of coating the magnetic nano-particles with gold using the laser irradiation method. Wet chemistry is meant here to include reduction methods, thermal decomposition methods and plasma methods. The main advantages of this method is that the overall yield is increased as well as the control on the size of the magnetic core.

Here there is described a protocol to make Fe@Au using the thermal decomposition of Fe(CO)₅ to synthesize the iron core followed by laser massaging to make the gold shell.

1. Fe nanoparticles were synthesized using the thermal decomposition of iron pentacarbonyl in argon atmosphere, as reported by Farrell et al., in 2003 (J. Phys. Chem. B v. 107, p. 11022). Particularly, 2.28 g of oleic acid (OA) was stirred in octyl ether, and the solution was heated at 100° C. Then, 0.3 ml of Fe(CO)₅ was added in a 1:3 molar ratio to the OA. Following the injection, the solution turned orange by the time it began to reflux (20 min); after another 70 min it turned black. The solution was then cooled down to room temperature. The produced Fe particles were re-dispersed in hexane (Solution A).

$${Fe ( CO )}_{5} {{⟶}^{Oleic acid}}_{octyl ether , 100 °C} Fe$$

2. A laser method was used to coat the nano-Fe with Au as follows:
A solution (Solution B) containing Au (>2 times of Fe in moill) in butanol/octane (15:15 ml) with CTAB (0.12 g) in 30 ml H₂O was prepared. Solutions A and B were mixed and irradiated for 1 hour at 532 nm (20 Hz, 250 mJ)
Irradiation mixed solution (A+B) with 1 h, 20 Hz laser pulse, 250 mJ (65 mJ) (Total energy input 65 mJ)

The mixture was centrifuged for 10˜15 min to separate the oil phase from the water phase. (Particles suspend in water)

The magnetic particles were collected using an external magnetic field. The collected magnetic particles were washed with acid solutions (HCl) to remove the non-coated or partially coated particles.

The Fe@Au nano-particles were re-dispersed in toluene using ultrasonication and dodecanthiol as stabilizing agent.

Characterization for the Microstructure and Composition of the Fe@Au Nanoparticles Produced by Hybrid Method Based on Example 2:

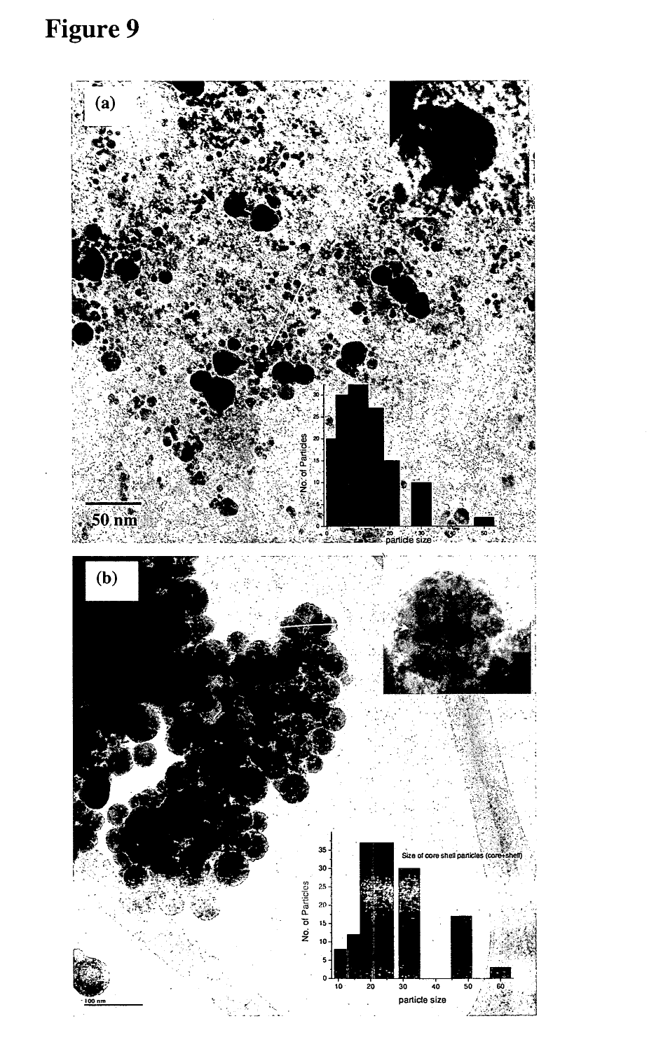

A. Bright field TEM was employed first to study the microstructure of the particles before and after the acid treatment. FIG. 9 depicts TEM micrographs and the corresponding particle size histograms for the Fe@Au particles before and after acid treatment. The average particle size was about 12 nm before the acid treatment (as shown in FIG. 9a), while it increased to 22 nm for the acid treated core shell particles (as shown in FIG. 9b). Those small particles in FIG. 9a were likely uncoated Fe and partially coated Fe. The magnified image in FIG. 9a indicates that the dark contrast was attributed to Au, while the bright contrast was from the Fe particles (8 nm) due to the lower electron density of Fe comparing with that of Au. The energy dispersive X-ray spectrometry (EDS) results displayed the element of Fe and Au in the particles. It has been shown that core-shell and multishell clusters can be kinetically favorable structures in the growth of bimetallic clusters. Therefore, the coating energy barrier could be much higher for coating 8 nm of Fe with Au thin layer in aqueous media than that of coating 12 nm of Fe with Au shell.

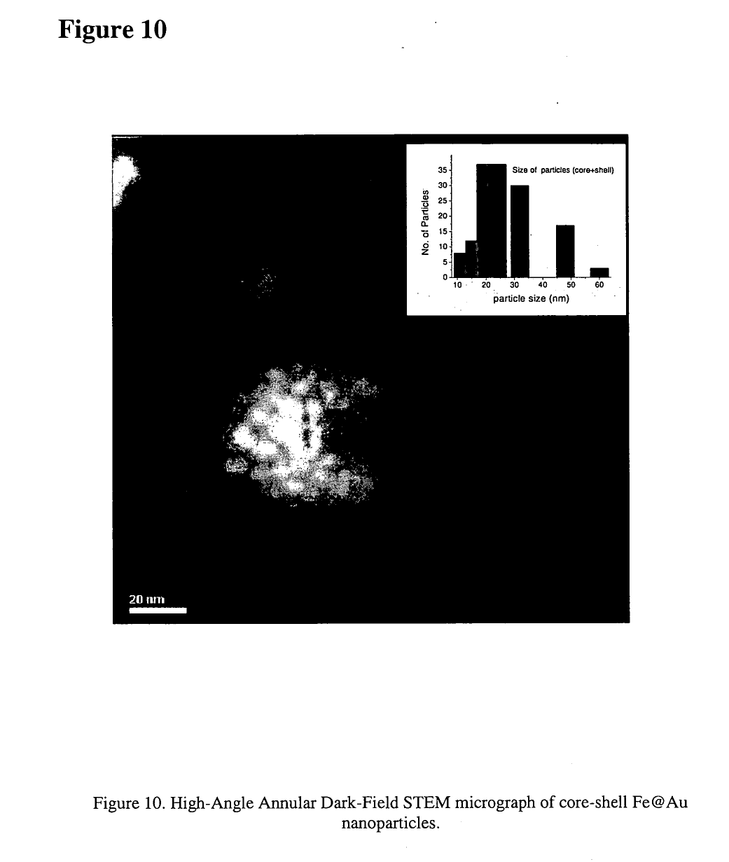

B. To avoid the non monotonic contrast, such as that generated by diffraction or Fresnel fringes, Z-contrast imaging, generated by high angle annular dark field (HAADF) scanning transmission electron microscopy (STEM) was carried to study the structure and morphology of the Fe@Au core shell nanoparticles. Haadf STEM micrograph of the acid treated Fe@Au particles is shown in FIG. 10. By using a STEM detector with a large inner radius, a HAADF detector, electrons were collected which are not Bragg scattered. As such HAADF images show little or no diffraction effects, and their intensity was approximately proportional to the square of atomic number (Z²). It clearly showed that the Au small clusters (bright dots) on the surface of core with the average diameter of 4 nm. Since Z² of Au (79²=6241) is much larger than that of Fe (26²=676), the strong contrast of Au shell is likely related to its atomic number.

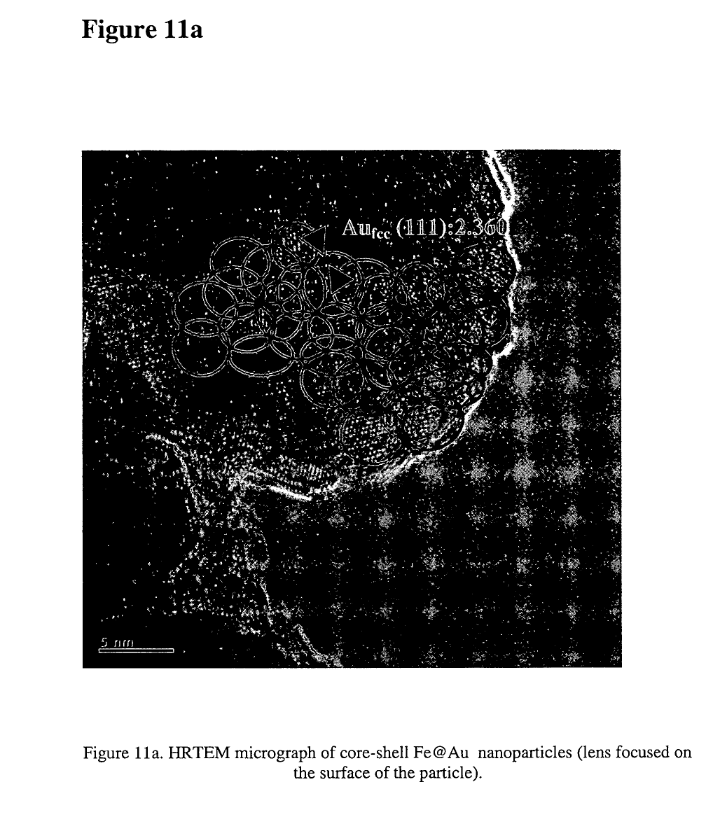

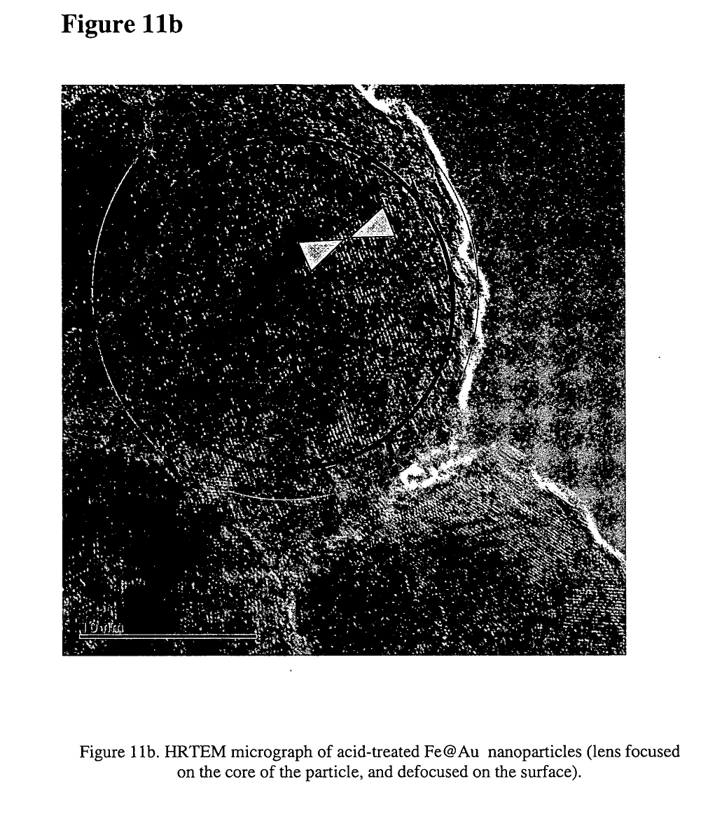

C. High resolution TEM (HRTEM) was employed to investigate the detail core-shell structures of the Fe@Au particles after acid treatment. (the objective lens focused on the surface of the particles). FIG. 11 a shows the multi-domain with same interplane distance (2.36) on the surface of particles, which was attributed to (111) Au_{fcc}. The size of each crystalline was about 3˜5 nm. When the objective lens was defocused on the surface of the particles, but focused on the center of the particles. A single domain crystallite with 18 nm in the diameter displays in FIG. 11b. The blur shell was observed due to the defocused. The interplane distance d=2.03 was attributed to (100) Fe_{bcc} which was parallel to the primary beam. Based on above studies, it can be estimated that the Fe core is about 10˜20 nm, and the Au shell is about 5˜10 nm after acid treatment.

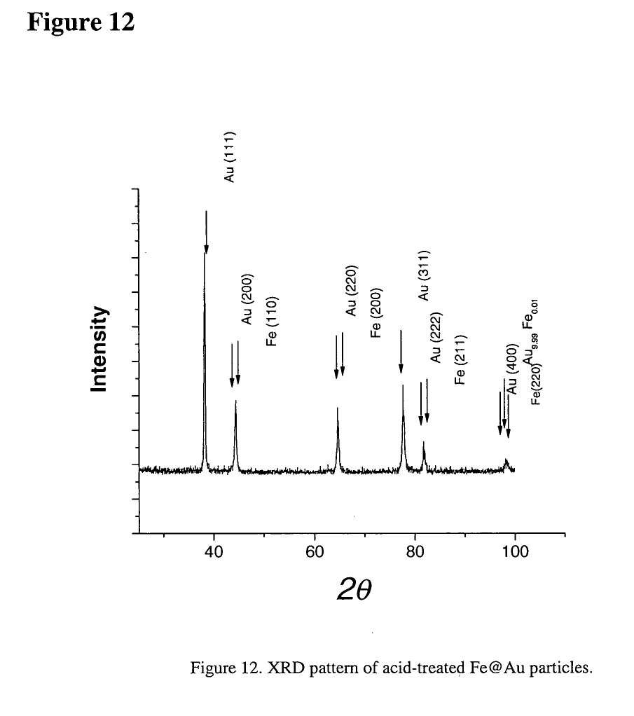

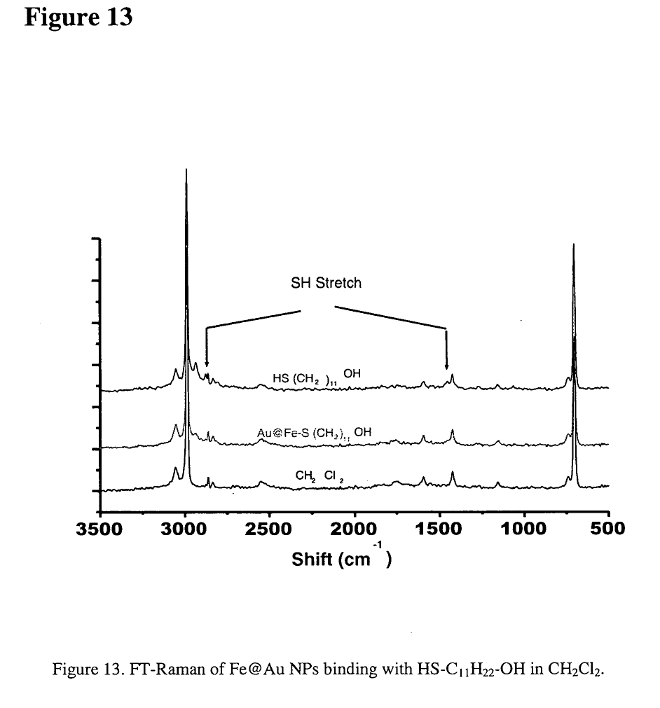

D. X-ray θ-2θ scattering scan with Cu Kα radiation (λ=1.54056 Å) was also used to study the acid-treated particles, which were dried in the vacuum. The scan range was from 25 to 100 degree with step size of 0.02 degree. XRD measurement (as shown in FIG. 12) indicated that in the core shell particles, there were only two Au and Fe phase. The oxide phase could not be observed. Fcc Fe and bcc Au have a small lattice mismatch at Fe (100) 2.036/Au (111) 2.364 , which might lead to the strong adhesion at the interface between Fe and Au.

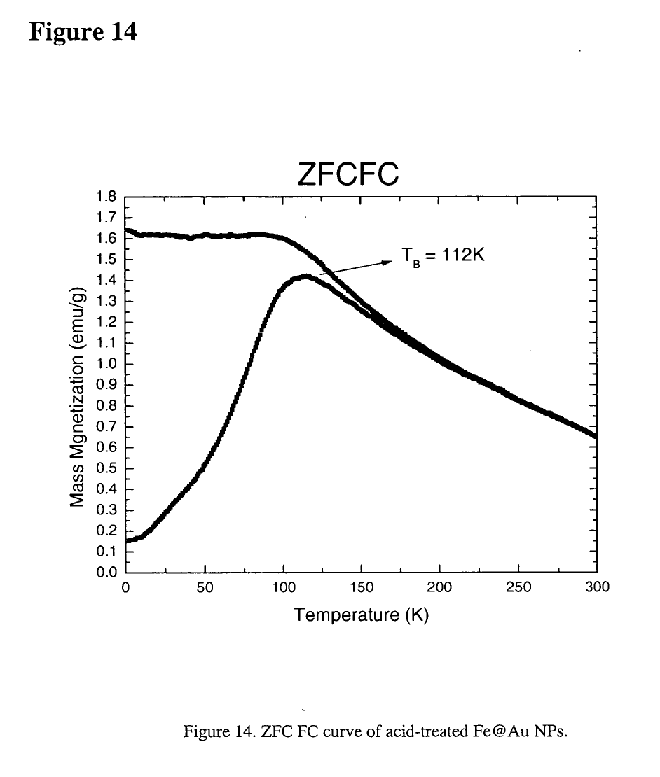

E. The interaction between the Au coated Fe core-shell particles and 1-mercapto-11-undodecanol was understood through FT-Raman. FIG. 14 shows the FT-Raman spectra after the acid treated Fe@Au were re-dispersed in dichloromethane (CH₂Cl₂) with stabilizing agent of 1-mercapto-11-undecanol (HS—C₁₁H₂₂—OH). The S—H stretch at 2700 cm⁻¹ and 1280 cm⁻¹ disappeared when the 1-mercapto-11-undecanol (HS—C₁₁H₂₂—OH) replaced CTAB by covalently coupling with Au shell. A surface plasmon peak with centering at 556 nm was also found in UV-vis absorption spectrum. The results indicate that there is a covalently coupling between S and Au. This could be exploited to permit binding to biomolecules or other molecules of interest to produce diagnostics, therapeutics and indicator compounds with defined or definable localization or binding characteristics.

Magnetic Properties:

The magnetic properties of Fe@Au nanoparticles were characterized using AC magnetometry. They are super-paramagnetic with a blocking temperature of about 112K (as shown in FIG. 14)

TABLE 1
The employed laser energy and irradiation
time for producing Fe@Au of Example 1

| | | |
|---|---|---|
| Wavelength (nm)/ | Pulse Energy | |
| Frequency | (mJ/pulse) | Duration (min) |

| | | | | |
|---|---|---|---|---|
| 532 nm | 50 | mJ | 60 | min |
| | 65 | mJ (better) | 90 | min |
| | 70 | mJ | 120 | min |
| | 50 | mJ | 60 | min |
| | 65 | mJ (better) | 90 | min |
| | 70 | mJ | 120 | min |
| | 50 | mJ | 60 | min |
| | 65 | mJ (better) | 90 | min |
| | 70 | mJ | 120 | min |

We claim:

1. A core having a volume of no more than about 1.2×10⁻⁴ μm³, said core being substantially coated in gold.

2. The core of claim 1 wherein the core is magnetic.

3. The core of claim 1 wherein the core is a super paramagnetic particle.

4. The core of claim 1 wherein the core is a nanoparticle.

5. The core of claim 1 wherein the core is a zero-valent metal. Fe, Co, Ni or FeCo, SmCo3, or a ferrite.

6. The core of claim 5 wherein the zero-valent metal includes at least one of Fe, Co, Ni or FeCo, SmCo3, or a ferrite.

7. The core of claim 1 having a diameter of at least 5 nm.

8. The core of claim 1 having a volume of between about 10 and 200 nm³.

9. The core of claim 1 having a volume of between about 50 and 150 nm³.

10. The cores of claim 4 having a diameter of less than about 15 nm.

11. A method of coating cores with gold, said method comprising:
a) obtaining cores in a suitable two phase oil:aqueous system wherein the aqueous phase includes suspended gold, and
b) subjecting the cores to irradiation at a wavelength within about 30 nm of a surface plasmon resonance of gold.

12. The method of claim 11 wherein the irradiation is conducted at a wavelength within about 20 nm of a surface plasmon resonance of gold.

13. The method of claim 11 wherein the irradiation is conducted at a wavelength within about 12 nm of a surface plasmon resonance of gold.

14. The method of claim 11 wherein the two phase system of step (a) further includes surfactant.

15. The method of claim 12 wherein the surfactant is hexadecyltrimethyl-amonium (“CTAB”).

16. The method of claim 11 wherein the aqueous phase of the 2-phase system is an alcohol:water mixture.

17. The method of claim 14 wherein the 2-phase system further includes a surfactant.

18. The method of claim 14 wherein the 2-phase system further includes an anti-oxidant.

19. The method of claim 11 wherein the oil phase of the 2-phase system is a C₈-C₁₅ alkane, a cyclohexane, or, a phenyl-substituted organic.

20. The method of claim 11 wherein the laser irradiation of step (b) is carried out so as to provide a total irradiation energy of between 50 and 300 mJ.

21. The method of claim 20 wherein the laser irradiation is carried out at between 15 and 25 Hz.

22. A method for forming iron nanoparticles, said method comprising:
a) obtaining Fe₂O₃ in a polar solvent, and
b) laser irradiating the Fe2O₃/solvent mixture to provide between about 40 and 100 mJ of total laser energy input at between about 15 to 25 Hz, so as to produce Fe.

23. A method of producing a fluid containing fragmented melted gold suitable for coating on a surface, said method comprising:
a) obtaining an aqueous solvent containing suspended gold;
b) irradiating the polar solvent containing gold at a wavelength within 30 nm of a plasmon resonance peak of gold.

24. A method of applying a material soluble in an aqueous phase to a second material, thereby reduce potential oxidation of the second material beyond the level which would be expected in a single-phase aqueous system, said method comprising:
a) obtaining the first material in an aqueous phase;
b) obtaining the second material in an oil phase;
c) combining the aqueous and oil phases to form a two-phase system; and
d) inducing the formation of micelles or reverse micelles in the two-phase system.
